(19) United States
(12) Patent Application Publication
(10) Pub. No.: US 2010/0183838 A1
(43) Pub. Date: Jul. 22, 2010

(54) Light Weight Panel and Method of Manufacture

(76) Inventor: Hector M. Coronado, Los Angeles, CA (US)

Correspondence Address: KLEINBERG & LERNER, LLP, 1875 CENTURY PARK EAST, SUITE 1150, LOS ANGELES, CA, 90067, US

(21) Appl. No.: 12/400,759

(22) Filed: Mar. 9, 2009

Related U.S. Application Data
(60) Provisional application No. 61/034,928, filed on Mar. 7, 2008.

(51) Int. Cl. B32B 23/00; B32B 3/02; B32B 37/10; B32B 3/28; E04F 13/072

(52) U.S. Cl. 428/47; 156/275.3; 156/196

(57) ABSTRACT

A light weight panel and method of manufacture. In a preferred embodiment the panel is manufactured by creating a frame of layered composite materials and placing a composite material face sheet on the frame. Then the frame and face sheet is cured in a press using radio frequency curing. In another preferred embodiment the composite materials are composed of renewable materials such as wheat board, bamboo, sunflower board, sorghum board, straw or rice hulls.

### BACKGROUND

This invention claims priority based upon U.S. provisional patent application Ser. No. 61/034,928, filed Mar. 7, 2008 and entitled “Light Weight Panel and Method of Manufacture.” Application Ser. No. 61/034,928 is incorporated thereto in its entirety herein by reference.

1. Field of the Invention

The present invention relates to a process for the creation of panels for use in furniture, cabinetry, closet industries, and recreational vehicles, whether marine, terrestrial or extraterrestrial and the resultant panels.

2. Description of the Related Art

Virtually everything in the furniture industry, including desks, cabinetry for kitchens or bathrooms, office furniture, panel systems for offices, cabinetry for the recreational vehicle industry including aircraft, marine and terrestrial vehicles, and furniture in general is manufactured with the concept of assembled panels of wood, plastic or other sheet materials.

The panels, if solid core, are generally heavy, contain formaldehyde glues or other potentially toxic materials. They are often just flat panels using non-renewable resources such as wood. Generally they are not completely bio-degradable or recyclable.

In the prior art, many panels are composites structures with a substrate of an inexpensive material such as particle board and with exterior surface layers of a veneer or plastic. In some cases the outer surfaces are metals. In an effort to reduce the weight of these panels, some manufacturers adopted honeycomb structures or hollow core technologies.

These techniques resulted in panels of reduced weight, but such panels still required processes employing pressure, elevated temperatures and, in some instances, steam to achieve panels that were not planar. Such processes required expensive and cumbersome machinery to achieve results.

What is needed is a process to produce a relatively lightweight panel that can be made of renewable and recyclable materials and which can be fabricated with more or less conventional forming equipment. It would also be desirable if such resultant panels could be made without toxic adhesives or other toxic volatile components.

### SUMMARY OF THE INVENTION

In a preferred embodiment of the present invention, a relatively thick composite particulate board is first cut into thin strips. These strips are then cut into thin strips which are assembled, in a predetermined order into a frame structure. Solid, facing sheets, which may be comprised of a composite material substrate optionally faced with a veneer or plastic material are then bonded to the frame and, utilizing a press that may include radio frequency heating, the facing sheets and frame members are bonded together and, if desired, bent to a predetermined shape by the application of heat and pressure which leads to the cure of the adhesive components.

The resulting panels can be used to fabricate working surfaces for cabinets, desks, tables, etc, that can resemble wood but can be made of sustainable non-forestry materials which are currently available in the market such as grasses, wheat straw or other agricultural waste materials. Heat curable formaldehyde-free adhesives are employed in creating the curved and flat surfaces resulting from the process of the preferred embodiment.

These panels are light in weight thanks to the method of manufacturing and the particular way disclosed to use the materials as substrates. The present invention consists in the creation of panels (curved or flat) that are susceptible of being manufactured in unlimited sizes and thicknesses and are processed with Radio Frequency induced heating as a source of curing and are made from the combination of the frame and the exterior surface sheets.

The manufacture of the products that use the panels described above can be fabricated without substantial change and can utilize the same end panels and edge moldings preferably, in a lighter weight. This will give designers of all consumer products the flexibility to create better looking units which may be easier to manufacture.

Another significant benefit is the use of sustainable certified forestry products, such as tree prunings which can be used to create veneers, all helping to reduce deforestation. At the same time, other sustainable agricultural products, presently considered waste, can be gainfully employed.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is a plan view of a panel according to the invention.

FIG. 2 is a plan view of the substrate frames of the present invention.

FIG. 3 is a plan view of an alternative frame configuration.

FIG. 4 is an exploded view of a preferred embodiment of the substrate frame and exterior surface sheets.

FIG. 5 is a schematic view of a press suitable for producing panels according to the present invention.

FIG. 6 is an exploded view of a cured panel according to the present invention.

### DETAILED DESCRIPTION OF THE INVENTION

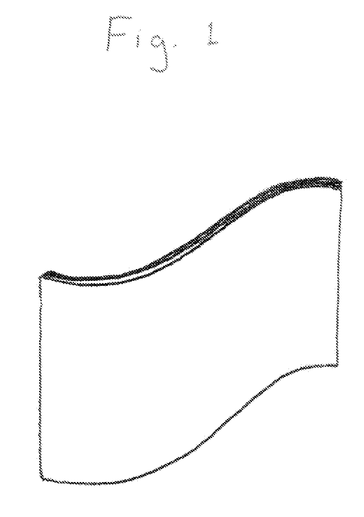

A preferred embodiment of a completed panel according to the present invention is shown in FIG. 1.

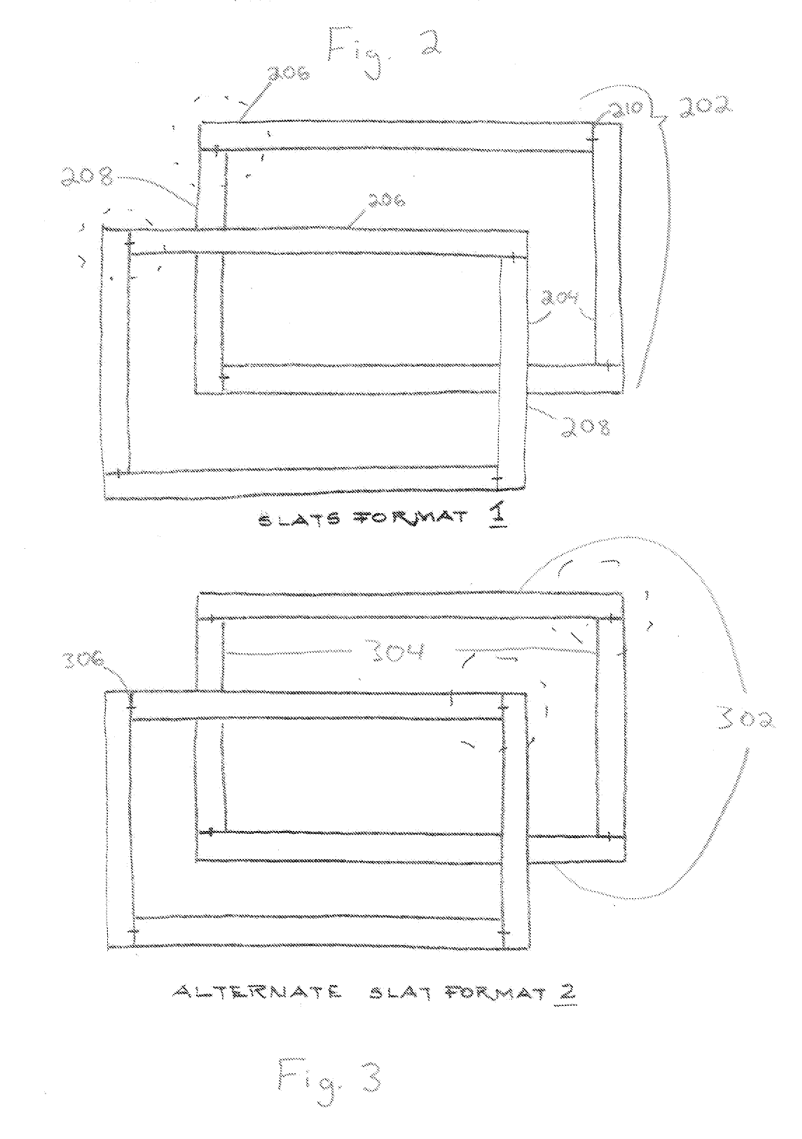

A preferred embodiment of the substrate frame 202 is shown in FIG. 2. The substrate frame 202 is made of a sustainable composite material such as wheatboard. Wheatboard is made from wheat fiber which is pressed into a board with a non-toxic agglutinant. Other renewable materials such as straw, grasses, and possibly rice hulls can also be employed to create panels.

Wheatboard is readily available in commercial sizes of 4′×4′ and may vary in thickness from ¼″ up to ¾″. For the preferred embodiment of this invention, slats or thin strips of 2″ inches in width and of varying length are cut from a ¾″ thick wheatboard. The slats are then sliced into ⅛″ inch thick strips, 204. To form a rectangular frame, two slats, the long side slats 206 become the “long” side of a rectangular frame and two shorter slats 208 form the “short” side. As shown in FIG. 2, two configurations are prepared, one in which the short slats 208, connect to the long slats 206 on a lower side and on an upper edge and the other where a lower edge meets with an upper side.

In the preferred embodiment as seen in FIG. 2, the four slats forming a rectangle are connected together with a staple, 210. However, other connecting means may be employed, such as brads.

In an alternate embodiment as seen in FIG. 3, two equal length slats, 304, are connected in the inner edge of two other equal length slats, 302. The slats are also connected via a staple, 306. To construct a frame for optimum strength, the embodiments are alternated, preferably in four courses which stack to create a frame.

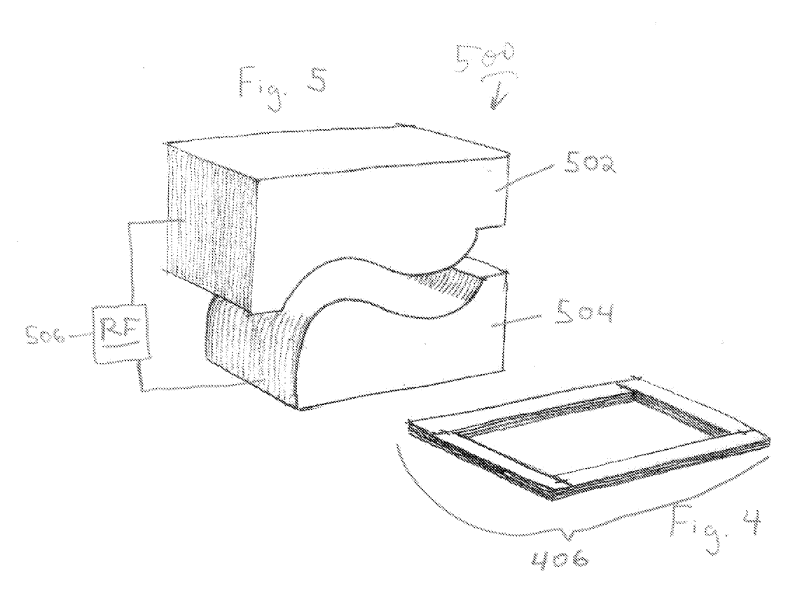

When the frames are being constructed, a film of glue is applied to each of the courses. The ⅛″ inch thick frames are then stacked together, one on top of the other as shown in FIG. 4. In the preferred embodiment, four such frames are stacked although fewer or greater courses may be employed. Further, the ⅛″ thickness, which is preferred, can, for a greater span panel, be increased by the addition of additional courses.

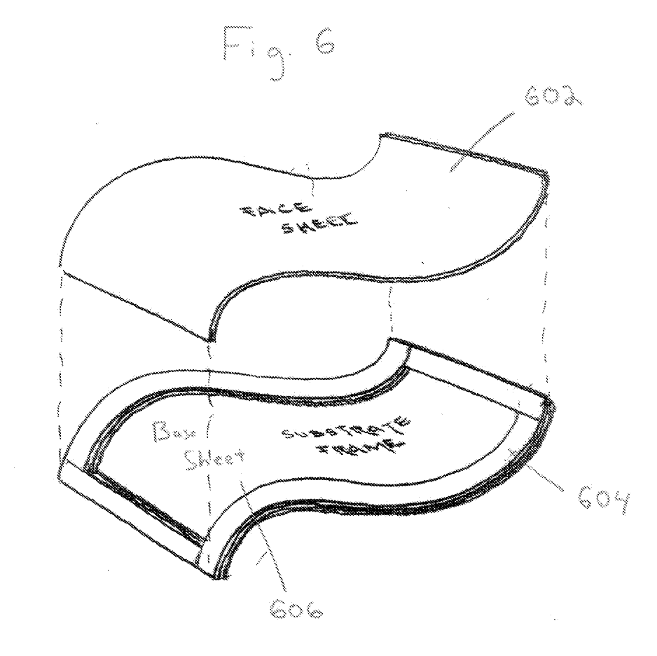

The stacked frames are then be put in a special mold 500, as seen in FIG. 5. The mold 500 has a top and bottom portion 502, 504, and a radio frequency emitting device 506 is connected to the mold 500. The special mold 500 may be configured in different shapes and sizes to create panels of different shapes and sizes. As seen in FIG. 5, the top and bottom portions 502, 504 of the mold 500, are complementary.

The frame, together with top and bottom surface sheets, is placed within the mold 500. Through the application of pressure and radio frequency induced heating, the panel elements are compressed and the glue is cured. The resulting panel achieves the desired shape. After curing, the panel becomes a strong solid unit ready to be finished, usually by the application of edge strips to hide the raw edges. Obviously, in some applications, the edges can be left without finishing, as where panels are incorporated in a structure that does not expose the edges.

Face sheets 602 as shown in FIG. 6, can be sustainable materials such as aluminum, fabric, linoleum, polycarbonate, etc., all of which can be are used to create a face sheet. In the preferred embodiment, the face panel 602 is ⅛″ in thickness. The face sheets can also be composite structures including a substrate such as particle board covered with a veneer which is preferably made from certified forest products

The face sheets 602 are then placed on the frame to form the panel, as shown in Figure. On the opposite side of the frame, opposite of the face sheet 602, a base sheet, 606, made of sustainable materials such as aluminum, fabric, linoleum, polycarbonate, etc. is placed.

Therefore, the advantage of the present invention is to provide a light weight panel and method of manufacture of the panel that is environmentally friendly. The preferred embodiment of this invention is particularly suited for curved panels. However, it is to be understood that various modifications may be used without departing from the principle of the present invention scope.

Accordingly, the breadth and scope of the invention should be limited only by the scope of the claims appended hereto.

What is claimed is:

1. A method for producing panels comprising the steps of:
a. assembling a frame structure;
b. applying an adhesive to said frame structure;
c. covering said frame structure with only one facing sheet overlying said frame structure;
d. placing said frame structure and facing sheet combination in a radio frequency press; and
e. applying compressive force and radio frequency energy to said press for shaping said facing sheet and frame structure combination to shape and cure said combination into an integral panel.

2. A panel produced according to the method of claim 1.

3. The method of claim 1, wherein said frame structure comprises thin strips of composite particulate board and said facing sheet is comprised of a composite material.

4. The method of claim 1, wherein said frame structure and said facing sheet are bent into a predetermined shape during curing.

5. The panel produced according to the method of claim 4.

6. The method of claim 1, wherein said frame structure comprises at least three layers of composite material.

7. The method of claim 6 wherein said layers of composite material are layered in an alternating arrangement, such that the connections between slats of alternating layers do not directly overlie each other.

8. The method of claim 1, wherein said facing sheet is selected from a group comprising wheat board, bamboo, sunflower board, sorghum board, straw, and rice hulls.

9. A panel comprising:
a. a frame structure;
b. an adhesive layer applied to said frame structure;
c. one facing sheet overlying said adhesive and covering said frame structure;
wherein said frame structure and said facing sheet are combined by applying compressive force and radio frequency energy in a radio frequency press to form an integral panel.

10. The panel of claim 9, wherein said frame structure comprises at least three layers of composite material.

11. The panel of claim 10, wherein said layers of composite material are layered in an alternating arrangement, such that the connections between slats of alternating layers do not directly overlie of each other.

12. The panel of claim 11, wherein said frame and said solid facing sheets are bent into a predetermined shape.

13. The panel of claim 9, wherein said solid facing sheets are selected from a group comprising wheat board, straw, grass and rice hulls.
